(19) United States
(12) Patent Application Publication
(10) Pub. No.: US 2018/0010510 A1
(43) Pub. Date: Jan. 11, 2018

(54) CONTROL DEVICE FOR INTERNAL COMBUSTION ENGINE

(71) Applicant: TOYOTA JIDOSHA KABUSHIKI KAISHA, Toyota-shi (JP)

(72) Inventor: Keisuke HAYASHI, Susono-shi (JP)

(73) Assignee: TOYOTA JIDOSHA KABUSHIKI KAISHA, Toyota-shi (JP)

(21) Appl. No.: 15/637,757

(22) Filed: Jun. 29, 2017

(30) Foreign Application Priority Data
Jul. 5, 2016 (JP) 2016-133618

(51) Int. Cl. F02B 23/10; F01N 3/20; F01N 3/26; F02P 13/00

(52) U.S. Cl. CPC F02B 23/10; F02P 13/00; F01N 3/2006; F01N 3/26; F02B 2023/103

(57) ABSTRACT

An upper part of FIG. 7 represents a catalyst warming-up control when a normal fuel is used, and a lower part of FIG. 7 represents the catalyst warming-up control when a heavy fuel is used. As understood from a comparison between the upper part and the lower part of FIG. 7, the start timing of the ignition period and the total injection amount of the injector in each cycle when the heavy fuel is used are the same as those when the normal fuel is used, though the ratio of the intake stroke injection and the expansion stroke injection to the total injection amount of the injector is changed to increase the fuel amount of the expansion stroke injection as compared with the case where the normal fuel is used.

### CROSS-REFERENCE TO RELATED APPLICATION

The present application claims priority under 35 U.S.C. §119 to Japanese Patent Applications No. 2016-133618, filed on Jul. 5, 2016. The contents of these applications are incorporated herein by reference in their entirety.

### TECHNICAL FIELD

The present application relates to a control device for an internal combustion engine and, more particularly, to a control device which is applied to a spark ignition internal combustion engine provided with an in-cylinder injector.

### BACKGROUND

An internal combustion engine disclosed in Patent Literature 1 (JP 2011-106377 A) comprises: an injector which has a plurality of injection holes; and a spark plug, the injector and the spark plug being provided in an upper part of a combustion chamber. In the internal combustion engine, a distance from a center position of a discharge gap of the spark plug to a center position of the injection hole which is closest to the spark plug among the plurality of injection holes is set within a specific range. In the internal combustion engine, a control for applying a high voltage to the spark plug is performed over a period from a time point after a lapse of a predetermined time from the start of a fuel injection to a time point when the fuel injection is completed.

In the above-described control, a fuel injection period of the injector overlaps with a period of applying the high voltage to the spark plug. When the fuel is injected by the injector which is supplied with the fuel in a pressurized condition, a low pressure area is formed by entraining air around the fuel spray injected from each injection hole (entrainment). Therefore, when the above-described control is performed, a discharge spark generated in the discharge gap is attracted to the low pressure area formed by the fuel spray from the injection hole closest to the spark plug. The internal combustion engine can thereby improve ignitability of an air-fuel mixture formed around the spark plug.

Patent Literature 1 further introduces activation of an exhaust gas cleaning catalyst as applications of the attraction action. Although not mentioned in Patent Literature 1, the exhaust gas cleaning catalyst is generally activated by changing an ignition period normally set near a compression top dead center (i.e., a period of applying a high voltage to the spark plug) to a period retarded from the compression top dead center.

When the above-described control of Patent Literature 1 is applied for the general activation of the exhaust gas cleaning catalyst, the ignition period set at a retarded side from the compression top dead center overlaps with a fuel injection period to improve the ignitability of the air-fuel mixture formed around the spark plug. However, if an igniting environment is changed due to some factors and therefore is out of a desired range, a combustion state may become unstable in spite of the attraction action. In combustion cycles during the control for activating the exhaust gas cleaning catalyst, when the number of combustion cycles in which such a situation occurs is increased, a combustion fluctuation between cycles becomes large, and drivability is affected.

The present application addresses the above problems, and an object of the present application is to suppress the combustion fluctuation between cycles when the control performed so that the fuel injection period of the injector overlaps with the period of applying the high voltage to the spark plug is applied for the activation of the exhaust gas cleaning catalyst.

### SUMMARY

A control device for an internal combustion engine according to the present application is a device for controlling an internal combustion engine comprising: an injector, a spark plug, and an exhaust gas cleaning catalyst. The injector is configured to be provided in an upper part of a combustion chamber and is configured to inject fuel from a plurality of injection holes into a cylinder. The spark plug is configured to ignite an air-fuel mixture in the cylinder using a discharge spark, and is provided on a downstream side of the fuel injected from the plurality of injection holes and above a contour surface of the fuel spray pattern which is closest to the spark plug among the fuel spray patterns injected from the plurality of injection holes. The exhaust gas cleaning catalyst is configured to clean an exhaust gas from the combustion chamber.

In order to activate the exhaust gas cleaning catalyst, the control device is configured to control the spark plug so as to generate the discharge spark in an ignition period retarded from a compression top dead center, and control the injector so as to perform first injection at a timing advanced from the compression top dead center and second injection at a timing retarded from the compression top dead center, the second injection being performed so that an injection period overlaps with at least a part of the ignition period.

The control device is further configured to divide an injection amount into first injection and second injection in accordance with an injection amount in each cycle and a previously set injection share ratio, and when an engine speed fluctuation is detected, change the injection share ratio without changing the injection amount in each cycle, so that the injection amount of the second injection is increased, and the injection amount of the first injection is reduced.

An air-fuel mixture containing the fuel spray by the first injection generates initial flame in the ignition period. When the second injection is performed so that an injection period overlaps with at least a part of the ignition period, at least the initial flame is attracted to the low pressure area formed around the fuel spray injected from the injection hole which is closest to the spark plug. When the second injection is performed, the attracted initial flame is brought into contact with the fuel spray injected by the second injection, and the fluctuation for growing the initial flame is to be promoted.

One of factors that cause the engine speed fluctuation is that the intended attraction of the initial flame cannot be achieved. This is because the combustion for growing the initial flame becomes unstable when the initial flame are brought into contact with the fuel spray injected by the second injection in a state where the intended attraction cannot be achieved. When the number of combustion cycles in which the combustion for growing the initial flame is unstable is increased, the combustion fluctuation between cycles becomes large.

In this regard, if the injection share ratio is changed to increase the injection amount of the second injection when the engine speed fluctuation is detected, the low pressure area for generating a large pressure difference is formed around the fuel spray injected by the second injection. That is, the initial flame are rapidly attracted to the low pressure area for generating the large pressure difference formed around the fuel spray injected from the injection hole closest to the spark plug and the other injection holes close to this injection hole. Therefore, the combustion for growing the initial flame can be stabilized, thereby suppressing the combustion fluctuation between cycles.

Since the lower pressure area for generating the large pressure difference is formed when the injection amount of the second injection is increased, the injection amount of the second injection may be simply increased when the engine speed fluctuation is detected. However, when the injection amount of the second injection is simply increased, an amount of hydrocarbon discharged in a non-combusted state from the internal combustion engine and an amount of fuel adhering to a wall surface of the combustion chamber are increased. Therefore, deterioration of the fuel consumption ratio cannot be avoided when the injection amount of the second injection is simply increased.

In this regard, if the injection share ratio is changed to increase the injection amount of the second injection and reduce the injection amount of the first injection without changing the injection amount in each cycle, such a problem can be avoided from occurring and the combustion fluctuation between cycles can be suppressed.

The control device may be configured to change the injection share ratio when the engine speed fluctuation is detected and the use of a heavy fuel is detected.

Another factor that causes the engine speed fluctuation is that the heavy fuel is used. The combustion for generating the initial flame from the air-fuel mixture containing the fuel spray by the first injection described above, as well as the combustion for growing the initial flame by the fuel spray by the second injection described above easily become unstable because the volatility of the heavy fuel is lower than that of a normal fuel.

If the injection share ratio is changed to reduce the injection amount of the first injection, the combustion for generating the initial flame may be further unstable. However, the low pressure area for generating the large pressure difference is formed around the fuel spray injected from the injection hole closest to the spark plug and the other injection holes close to this injection hole by changing the injection share ratio to increase the injection amount in the second injection as described above. If the injection share ratio is changed to increase the injection amount of the second injection, an amount of an atomized fuel is increased as compared with that before the change of the injection share ratio because the volatility ratio is independent to the fuel amount. Therefore, even if the combustion for generating the initial flame is unstable by reducing the injection amount of the first injection, the combustion for growing the initial flame is promoted to eliminate the unstable combustion, thereby suppressing the combustion fluctuation between cycles.

The control device may be further configured to change a start timing of the ignition period to an advanced side when the engine speed fluctuation is detected though the first injection and the second injection are performed at the changed injection share ratio.

If the start timing of the second injection is changed to the advanced side, the start timing of the second injection approaches the compression top dead center. An in-cylinder volume is reduced near the compression top dead center and an in-cylinder temperature is increased. If the start timing of the second injection is thus changed to the advanced side, the atomization of the heavy fuel is promoted by the second injection performed at a relatively high in-cylinder temperature, thereby suppressing the combustion fluctuation between cycles.

The control device may be configured to change the start timing of the second injection to the advanced side by the same amount as the advanced amount of the start timing of the ignition period when the start timing of the ignition period is changed to the advanced side.

If the start timing of the ignition period is changed to the advanced side by the same amount as the advanced amount of the start timing of the second injection, the attraction action can be achieved without generating a difference between after and before the change of the start timing of the second injection to the advanced side, thereby preventing from affecting the atomization of the heavy fuel promoted by the second injection performed at the relatively high in-cylinder temperature unexpectedly.

When the engine speed fluctuation is not detected after the start timing of the ignition period is changed to the advanced side, the control device may be further configured to change the start timing of the ignition period to a retarded side from the start timing before the change to the advanced side.

If the start timing of the ignition timing is changed to the advanced side, exhaust energy to be applied to the exhaust gas cleaning catalyst is reduced as compared with the case where the start timing of the ignition period is not changed to the advanced side, and the intended activation of the exhaust gas cleaning catalyst may not be achieved.

With this regard, when the engine speed fluctuation is not detected after the start timing of the ignition period is changed to the advanced side, the exhaust energy reduced in response to the change of the start timing of the ignition period to the advanced side can be compensated by changing the start timing of the ignition period to the retarded side from the start timing before the change to the advanced side.

The control device may be configured to change the start timing of the second injection to the retarded side by the same amount as the retarded amount of the start timing of the ignition period when the start timing of the ignition period is changed to the retarded side from the start timing before the change to the advanced side.

If the start timing of the second injection is changed to the retarded side by the same amount as the retarded amount of the start timing of the ignition period, the attraction action can be achieved without generating a difference between after and before the change of the start timing of the ignition period to the retarded side, thereby preventing from unexpectedly affecting the compensation of the exhaust energy performed by changing the ignition period to the retarded side.

The control device may be further configured to calculate the retarded amount when the start timing of the ignition period is changed to the retarded side in accordance with a loss of the exhaust energy, a remaining time and an intake air amount generated with the change of the start timing of the ignition period to the advanced side.

In this case, the loss of the exhaust energy may be calculated in accordance with an advanced amount when the start timing of the ignition period is changed to the advanced side, and the total amount of the intake air when the start timing of the ignition period is changed to the advanced side. The remaining time may be a time remaining during a period from a time point when the engine speed fluctuation is not detected after the start timing of the ignition period is changed to the advanced side to a time point when the control for activating the exhaust gas cleaning catalyst is completed. The intake air amount may be an air amount taken into the internal combustion engine at a time point when the engine speed fluctuation is not detected after the start timing of the ignition period is changed to the advanced side.

If the retarded amount when the start timing of the ignition period is changed to the retarded side is calculated in accordance with the above-described three elements, the activation of the exhaust gas cleaning catalyst can be achieved before the completion of the control for activating the exhaust gas cleaning catalyst.

A control device for an internal combustion engine according to the present application can suppress a combustion fluctuation between cycles when a control performed so that a fuel injection period of an injector having a plurality of injection holes overlaps with a period of applying a high voltage to a spark plug is applied for activation of an exhaust gas cleaning catalyst.

### BRIEF DESCRIPTION OF DRAWINGS

FIG. 1 is a diagram illustrating a system configuration according to a first embodiment of the present application;

FIG. 2 is a diagram illustrating an outline of a catalyst warming-up control;

FIG. 3 is a diagram illustrating an expansion stroke injection;

FIG. 4 is a diagram illustrating an attraction action of a discharge spark and initial flame by the expansion stroke injection;

FIG. 5 is a diagram illustrating a problem when a total injection amount of an injector 30 in each cycle is increased in the catalyst warming-up control;

FIG. 6 is a time chart illustrating a problem when a total injection amount of an injector 30 in each cycle is increased in the catalyst warming-up control;

FIG. 7 is a diagram illustrating an outline of a catalyst warming-up control according to the first embodiment of the present application;

FIG. 8 is a graph showing an example of an injection share ratio when a heavy fuel is used;

FIG. 9 is a time chart illustrating an example of the catalyst warming-up control according to the first embodiment of the present application;

FIG. 10 is a flowchart illustrating an example of a process performed by an ECU 40 in the first embodiment of the present application;

FIG. 11 is a diagram illustrating an outline of a catalyst warming-up control according to a second embodiment of the present application;

FIG. 12 is a time chart illustrating an example of a catalyst warming-up control according to the second embodiment of the present application;

FIG. 13 is a flowchart illustrating an example of a process performed by an ECU 40 in the second embodiment of the present application;

FIG. 14 is a time chart illustrating an example of a catalyst warming-up control according to a third embodiment of the present application; and

FIG. 15 is a flowchart illustrating an example of a process performed by an ECU 40 in the third embodiment of the present application.

### DESCRIPTION OF EMBODIMENTS

Hereafter, embodiments of the present application are described based on the drawings. Note that common elements in the respective figures are denoted by the same signs, and the duplicated descriptions are omitted. The present application is not limited by the following embodiments.

### First Embodiment

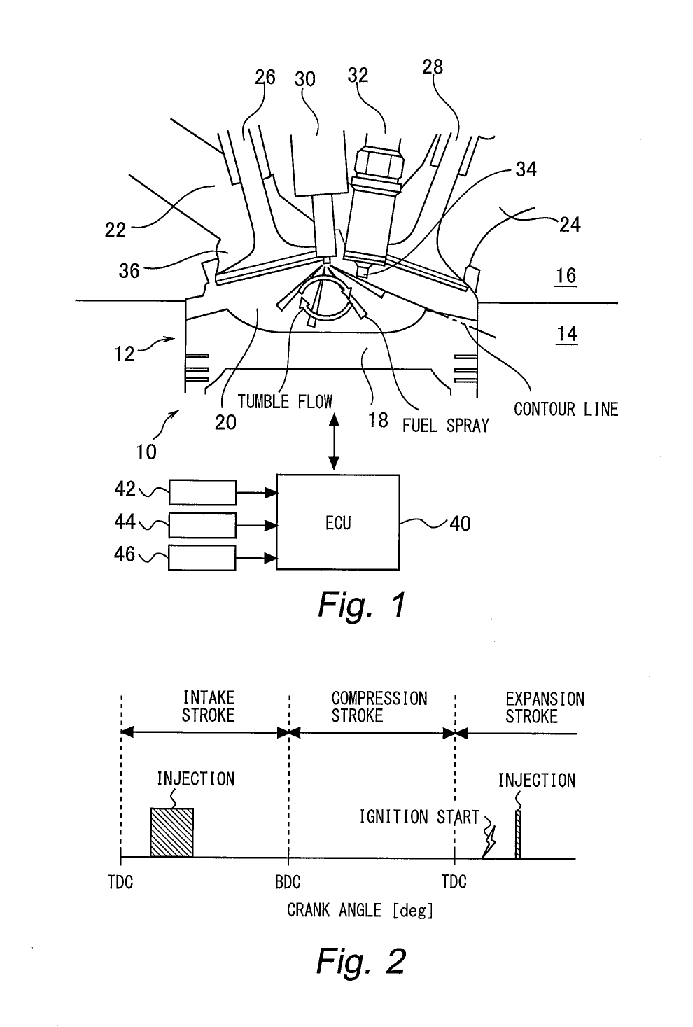

A first embodiment of the present application is described with reference to FIGS. 1 to 10.

### Description of System Configuration

FIG. 1 is a diagram illustrating a system configuration according to the first embodiment of the present application. As illustrated in FIG. 1, a system according to the present embodiment includes an internal combustion engine 10 mounted in a vehicle. The internal combustion engine 10 is a four-stroke one-cycle engine. The internal combustion engine 10 has a plurality of cylinders, and one cylinder 12 is illustrated in FIG. 1. The internal combustion engine 10 includes a cylinder block 14 in which the cylinder 12 is formed, and a cylinder head 16 disposed on the cylinder block 14. A piston 18 is disposed in the cylinder 12, the piston 18 reciprocatingly moving in an axial direction of the piston 18 (a vertical direction in the present embodiment). A combustion chamber 20 of the internal combustion engine 10 is defined by at least a wall surface of the cylinder block 14, a bottom surface of the cylinder head 16, and a top surface of the piston 18.

Two intake ports 22 and two exhaust ports 24 which are communicated with the combustion chamber 20 are formed in the cylinder head 16. An intake valve 26 is provided in an opening of the intake port 22 which is communicated with the combustion chamber 20. An exhaust valve 28 is provided in an opening of the exhaust port 24 which is communicated with the combustion chamber 20. An injector 30 is provided in the cylinder head 16 so that a tip of the injector 30 faces the combustion chamber 20 from substantially center of an upper part of the combustion chamber 20. The injector 30 is connected to a fuel supply system including a fuel tank, a common rail, a supply pump, and the like. The tip of the injector 30 has a plurality of injection holes arranged radially. When a valve of the injector 30 is opened, fuel is injected from these injection holes in a high pressure state.

In the cylinder head 16, a spark plug 32 is provided so as to be located on the exhaust valve 28 side of the injector 30 and in the upper part of the combustion chamber 20. The spark plug 32 has an electrode part 34 at a tip thereof, the electrode part 34 including a center electrode and a ground electrode. The electrode part 34 is disposed so as to protrude to an area above a contour surface of a fuel spray pattern (hereinafter also referred to as an “outer spray pattern”) injected from the injector 30 (i.e., an area from the outer spray pattern to the bottom surface of the cylinder head 16). More particularly, the electrode part 34 is disposed so as to protrude to the area above the contour surface of the fuel spray pattern which is closest to the spark plug 32 among the fuel spray patterns injected radially from the injection holes of the injector 30. Note that a contour line drawn in FIG. 1 represents the contour surface of the fuel spray pattern which is closest to the spark plug 32 among the fuel spray patterns injected from the injector 30.

The intake port 22 extends substantially straight from an inlet on an intake passage side toward the combustion chamber 20. A flow passage cross-sectional area of the intake port 22 is reduced at a throat 36 which is a connection part with the combustion chamber 20. Such a shape of the intake port 22 generates a tumble flow in intake air which flows from the intake port 22 into the combustion chamber 20. The tumble flow swirls in the combustion chamber 20. More particularly, the tumble flow proceeds from the intake port 22 side to the exhaust port 24 side in the upper part of the combustion chamber 20, and then proceeds from the upper part of the combustion chamber 20 downward at the exhaust port 24 side. The tumble flow proceeds from the exhaust port 24 side to the intake port 22 side in the lower part of the combustion chamber 20, and then proceeds from the lower part of the combustion chamber 20 upward at the intake port 22 side. A recess is formed on the top surface of the piston 18 forming the lower part of the combustion chamber 20 in order to conserve the tumble flow.

As illustrated in FIG. 1, the system according to the present embodiment includes an ECU (Electronic Control Unit) 40 as control means. The ECU 40 includes a RAM (Random Access Memory), a ROM (Read Only Memory), a CPU (Central Processing Unit), and the like. The ECU 40 receives signals from various sensors mounted on the vehicle, and processes the received signals. The sensors include at least an air flow meter 42 which is provided in the inlet of the intake passage and detects an intake air amount in the internal combustion engine 10, a crank angle sensor 44 which detects a rotation angle of a crankshaft connected to the piston 18, and a temperature sensor 46 which detects a temperature of coolant in the internal combustion engine 10. The ECU 40 processes the signals received from the individual sensors to operate various actuators according to a predetermined control program. The actuator operated by the ECU 40 includes at least the injector 30 and the spark plug 32 described above.

### Starting Control by ECU 40

In the present embodiment, the control for promoting the activation of an exhaust gas cleaning catalyst (hereinafter also referred to as “catalyst warming-up control”) is performed by the ECU 40 illustrated in FIG. 1 over a set time immediately after the cold start-up of the internal combustion engine 10. The exhaust gas cleaning catalyst is a catalyst which is provided in an exhaust passage of the internal combustion engine 10.

An example of the exhaust gas cleaning catalyst includes a three-way catalyst which cleans nitrogen oxides (NOx), hydrocarbons (HC), and carbon monoxide (CO) in the exhaust gas when the atmosphere of the catalyst in an activated state is near the stoichiometry. The above-described set time is calculated by the ECU 40 in accordance with a detection value of the temperature sensor 46 when starting the internal combustion engine 10.

The catalyst warming-up control performed by the ECU 40 is described with reference to FIGS. 2 to 7. FIG. 2 illustrates a timing of the injection by the injector 30 and a starting timing of an ignition period of the spark plug 32 (a starting timing of a discharge period of the electrode part 34) during the catalyst warming-up control. As illustrated in FIG. 2, during the catalyst warming-up control, the injector 30 performs first time injection (first injection) in an intake stroke, and then performs second time injection (second injection) with an amount smaller than the first time injection in an expansion stroke after a compression top dead center. Note that, in the following description, the first time injection (first injection) is referred to as “intake stroke injection,” and the second time injection (second injection) is referred to as “expansion stroke injection.” As illustrated in FIG. 2, during the catalyst warming-up control, the starting timing of the ignition period of the spark plug 32 is set to a timing retarded from the compression top dead center.

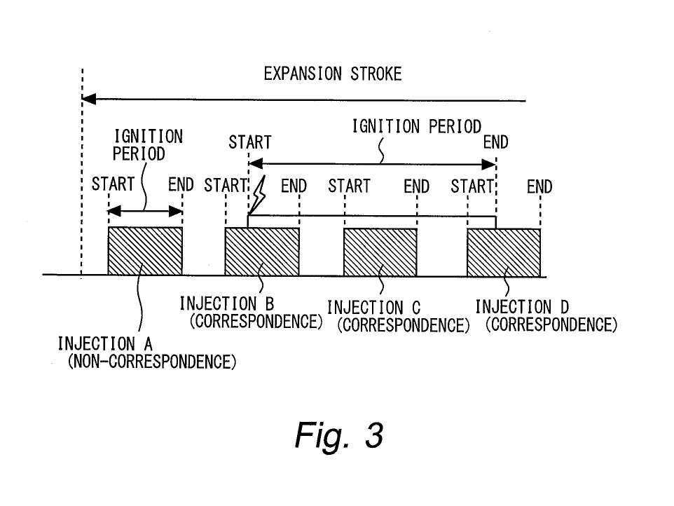

In FIG. 2, the expansion stroke injection is performed at a timing retarded from the starting timing of the ignition period, but the expansion stroke injection may be started at a timing advanced from the starting timing of the ignition period. In this regard, the description is provided with reference to FIG. 3. FIG. 3 is a diagram illustrating a timing relationship between an injection period and an ignition period in the expansion stroke injection. FIG. 3 illustrates four injections A, B, C and D which are started at different timings, respectively. The injections A, B, C and D are started at different timings, respectively, but all injection periods thereof have the same length in the expansion stroke injection. The ignition period illustrated in FIG. 3 is equal to the ignition period during the catalyst warming-up control (setting period). In the present embodiment, the injection B performed during which the ignition period is started, the injection C performed during the ignition period, and the injection D performed during which the ignition period is completed, as illustrated in FIG. 3, correspond to the expansion stroke injection. The injection A performed at a timing advanced from the start timing of the ignition period does not correspond to the expansion stroke injection in the present embodiment. This is because it is necessary that at least a part of the injection period overlaps with the ignition period in the expansion stroke injection in order to achieve an attraction action described later.

### Attraction Action by Expansion Stroke Injection

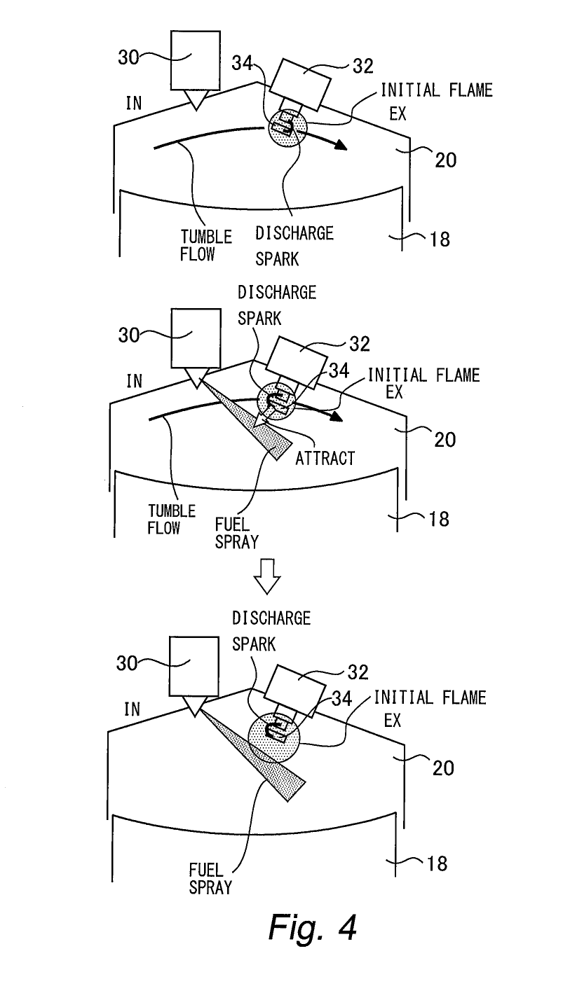

FIG. 4 is a diagram illustrating an attraction action of a discharge spark and initial flame in the expansion stroke injection. An upper part and a middle part (or a lower part) of FIG. 4 illustrate two different states of the discharge spark generated by the electrode part 34 during the ignition period of the spark plug 32 and the initial flame generated from the discharge spark and an air-fuel mixture containing the fuel spray injected by the intake stroke injection, respectively. The upper part of FIG. 4 illustrates a state where the expansion stroke injection is not performed. The middle part (or the lower part) of FIG. 4 illustrates a state where the expansion stroke injection is performed. Note that, for convenience of the description, FIG. 4 illustrates only fuel spray pattern which is closest to the spark plug 32 among fuel spray patterns injected by the expansion stroke injection.

As illustrated in the upper part of FIG. 4, when the expansion stroke injection is not performed, the discharge spark generated by the electrode part 34 and the initial flame extend in a tumble flow direction. On the other hand, as illustrated in the middle part of FIG. 4, when the expansion stroke injection is performed, a low pressure area is formed around the fuel spray (entrainment), and the discharge spark generated by the electrode part 34 and the initial flame are attracted in a direction opposite to the tumble flow direction. Thus, as illustrated in the lower part of FIG. 4, the attracted discharge spark and initial flame are brought into contact with the fuel spray injected by the expansion stroke injection, is entrained in the fuel spray, and grows rapidly. The growth of the initial flame caused by both of the discharge spark and initial flame thus attracted occurs in the injections B and C in illustrated in FIG. 3. The growth of the initial flame in the injection D in FIG. 3 is described later.

The fuel spray injected in the expansion stroke is affected by the tumble flow and the in-cylinder pressure. When the expansion stroke injection is performed at a timing advanced from the starting timing of the ignition period of the spark plug 32 (see the injection A in FIG. 3), the fuel spray injected by this injection changes in its shape before reaching the electrode part 34. As a result, a concentration of the air-fuel mixture around the spark plug is unstable, and a combustion fluctuation between cycles becomes large. However, if the expansion stroke injection is performed so that at least a part of the injection period overlaps with the ignition period (see the injections B, C in FIG. 3), the attraction action illustrated in the middle part of FIG. 4 can be achieved. Even if the fuel spray injected by the expansion stroke injection changes in its shape, the combustion for growing the initial flame (hereinafter also referred to as “initial combustion”) can be stabilized, thereby suppressing the combustion fluctuation between cycles. Furthermore, the combustion following the initial combustion or the grown initial flame can stabilize the combustion involving most of the fuel spray injected by the intake stroke injection (hereinafter also referred to as “main combustion”). In the injection D illustrated in FIG. 3, the discharge spark disappears when the ignition period is completed, but the initial flame remains. The attraction action caused by the fuel spray injected by the expansion stroke injection allows the initial flame to be brought into contact with the fuel spray. Accordingly, the initial flame is stabilized similarly to the cases of the injections B, C illustrated in FIG. 3, thereby suppressing the combustion fluctuation between cycles.

### Fuel Injection Amount during Catalyst Warming-up Control

In each cycle during the catalyst warming-up control, the ECU 40 calculates the total injection amount (i.e., sum of the injection amount in the intake stroke injection and the injection amount in the expansion stroke injection) injected from the injector 30 so as to maintain an in-cylinder air-fuel ratio A/F constant (as an example, stoichiometry). The increase in the fuel fluctuation between cycles caused by the fluctuation of the in-cylinder air-fuel ratio A/F can be suppressed by maintaining the in-cylinder air-fuel ratio A/F constant. In each cycle during the catalyst warming-up control, a ratio of the intake stroke injection and the expansion stroke injection to the total injection amount of the injector 30 (hereinafter simply referred to as an “injection share ratio”) is set at a predetermined value.

### Problems during Catalyst Warming-up Control

As described above, since the catalyst warming-up control is performed immediately after the cold start-up of the internal combustion engine 10, the combustion state easily becomes unstable. Particularly, when a heavy fuel is supplied to a vehicle with the internal combustion engine 10, the heavy fuel is injected from the injector 30 during the catalyst warming-up control. As compared with a case where a normal fuel is injected from the injector 30, the combustion for generating the initial flame from the air-fuel mixture containing the fuel spray by the intake stroke injection and the combustion for growing the initial flame by bringing into contact with the fuel spray injected by the expansion stroke injection (i.e. initial combustion) easily become unstable.

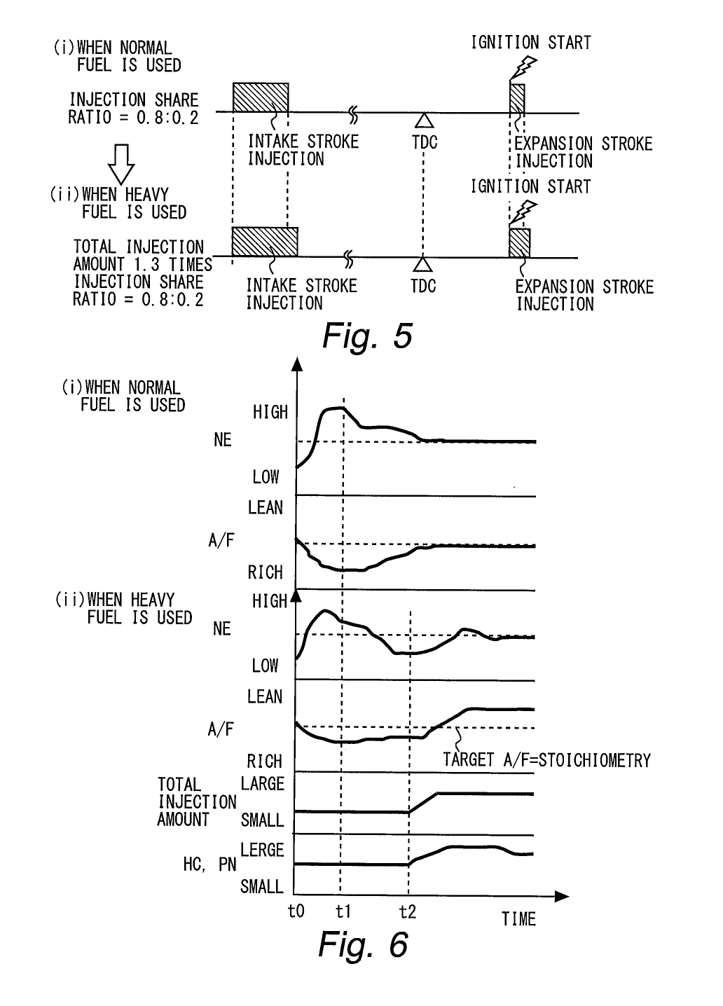

The causes of this problem are that the in-cylinder temperature is low immediately after the cold start-up of the internal combustion engine 10, and the volatility of the heavy fuel is lower than that of the normal fuel. Accordingly, when the heavy fuel is used, the total injection amount of the injector 30 in each cycle is increased to increase the volatile component amount, thereby the above-described problem can be solved. This countermeasure is described in detail with reference to FIG. 5. An upper part (i) of FIG. 5 represents the catalyst warming-up control when the normal fuel is used, and a lower part (ii) of FIG. 5 represents the catalyst warming-up control when the heavy fuel is used.

As understood from a comparison between the upper part (i) and the lower part (ii) of FIG. 5, the injection share ratio (as an example, intake stroke injection:expansion stroke injection=0.8:0.2) and the start timing of the ignition period (as an example, ATDC 25°) when the heavy fuel is used are the same as those when the normal fuel is used, though the total injection amount of the injector 30 in each cycle is increased as compared with that when the normal fuel is used (as an example, 1.3 times the total injection amount when the normal fuel is used). Thereby, the combustion for generating the initial flame and the initial combustion can be stabilized similarly to the case of using the normal fuel.

However, when the total injection amount of the injector 30 in each cycle is increased, another problem occurs. This problem is described with reference to a time chart of FIG. 6. An upper part (i) of FIG. 6 represents a time chart of the catalyst warming-up control when the normal fuel is used, and a lower part (ii) of FIG. 6 represents a time chart of the catalyst warming-up control when the heavy fuel is used. Note that in FIG. 6, the internal combustion engine 10 is started up at a time t₀, and the catalyst warming-up control is started from a time t₁. As understood from a comparison between the upper part (i) and the lower part (ii) of FIG. 6, transition of the engine speed NE from the t₁ to a time t₂ when the heavy fuel is used declines more largely than that when the normal fuel is used.

In the lower part (ii) of FIG. 6, the total injection amount of the injector 30 in each cycle starts to increase at the time t₂. As understood from the transition of the engine speed NE after the time t₂, when the total injection amount is increased, the engine speed NE is gradually increased and is converged to a certain value. However, when the total injection amount is increased, an amount of hydrocarbon discharged in a non-combusted state from the internal combustion engine 10 is increased. When the total injection amount is increased, the above-described volatile component amount as well as an unvolatile component amount are increased, and an amount of fuel adhering to the wall surface of the combustion chamber 20 is also increased. Accordingly, as illustrated in the lower part (ii) of FIG. 6, the amount of HC (hydrocarbon) and PN (the number of particles) are increased after the time t₂. Furthermore, when the total injection amount is increased, the fuel consumption ratio is deteriorated.

### Characteristic of Catalyst Warming-up Control According To First Embodiment

In view of such problems, when the combustion fluctuation between cycles is detected, the catalyst warming-up control according to the present embodiment is performed to change the injection share ratio without changing the total injection amount of the injector 30 in each cycle so that the fuel amount of the expansion stroke injection is increased and the fuel amount of the intake stroke injection is reduced.

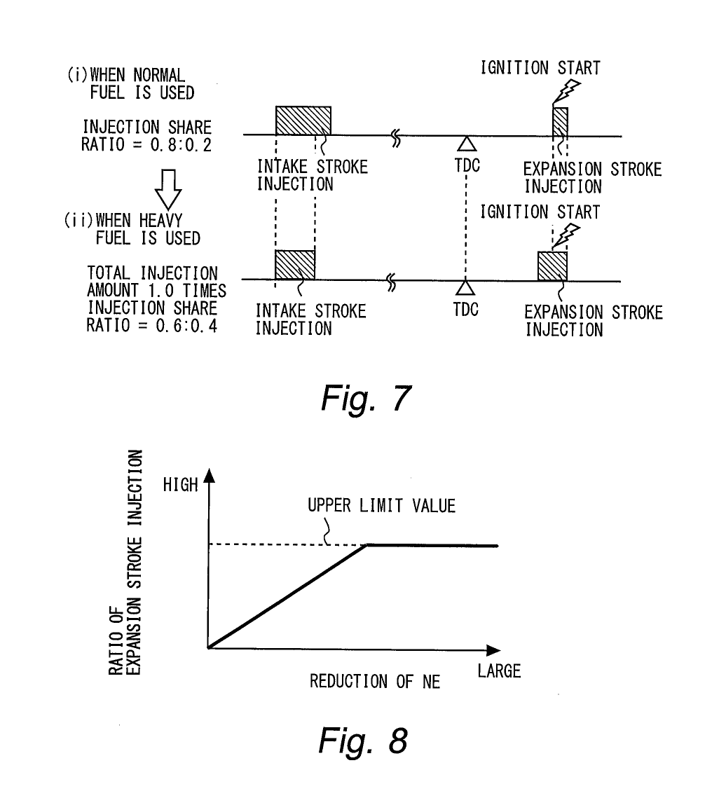

FIG. 7 is a diagram illustrating an outline of the catalyst warming-up control according to the first embodiment of the present application. Each of an upper part (i) and a lower part (iii) of FIG. 7 represents the outline of the catalyst warming-up control according to the present embodiment, though the upper part (i) illustrates the catalyst warming-up control when the normal fuel is used and the lower part (iii) illustrates catalyst warming-up control when the heavy fuel is used. Note that the upper part (i) of FIG. 7 is the same in content as the upper part (i) of FIG. 5. As understood from a comparison between the upper part (i) and the lower part (iii) of FIG. 7, the start timing of the ignition period and the total injection amount of the injector 30 in each cycle when the heavy fuel is used are the same as those when the normal fuel is used, though the injection share ratio is changed to increase the fuel amount of the expansion stroke injection as compared with that when the normal fuel is used (as an example, intake stroke injection : expansion stroke injection=0.6:0.4). To change the injection share ratio, the completion timing of the intake stroke injection is adjusted so that the start timing of the intake stroke injection is aligned with that when the normal fuel is used. Also, the start timing of the expansion stroke injection is adjusted so that the completion timing of the expansion stroke injection is aligned with that when the normal fuel is used. As a result, the completion timing of the intake stroke injection and the start timing of the expansion stroke injection are set at the timing advanced from the corresponding timings when the normal fuel is used.

When the total injection amount of the injector 30 in each cycle is equal to that when the normal fuel is used and the injection share ratio is changed to increase the injection amount of the expansion stroke injection as compared with the case where the normal fuel is used, the injection amount of the intake stroke injection is reduced as compared with the case where the normal fuel is used. Thus, the combustion for generating the initial flame may be further unstable because the heavy fuel is also used. However, by increasing the injection amount of the expansion stroke injection as compared with the case where the normal fuel is used, the low pressure area for generating a larger pressure difference than that when the normal fuel is used is formed around the fuel spray injected by the expansion stroke injection, thereby rapidly attracting the discharge spark and initial flame generated in the ignition period to the low pressure area. Therefore, the initial combustion can be stabilized.

Particularly, as illustrated in the lower part (iii) of FIG. 7, when the start timing of the expansion stroke injection is set at the timing advanced from the start timing of the ignition period by changing the start timing of the expansion stroke injection to the advanced side, heavy fuel injected in a relatively early stage out of the heavy fuel injected between the start of the expansion stroke injection and the start of the ignition period in the expansion stroke injection can gain a time required for the atomization of the heavy fuel. Therefore, the attracted discharge spark and initial flame can be brought into contact with the adequately atomized heavy fuel. In such a case, the initial combustion can be further stabilized.

In the lower part (iii) of FIG. 7, since the start timing of the expansion stroke injection is aligned with the start timing of the ignition period when the normal fuel is used, a relationship between both timings are as described as above. However, even if a period from the start timing of the ignition period to the start timing of the expansion stroke injection is slightly long in a stage where the normal fuel is used, when the start timing of the expansion stroke injection is set at the timing advanced from the start timing of the ignition period by changing the start timing of the expansion stroke injection to the advanced side, the effects which are substantially the same as those of the lower part (iii) of FIG. 7 can be obtained. When the start timing of the expansion stroke injection is set at the timing advanced from the start timing of the ignition period from the stage where the normal fuel is used (see the injection B of FIG. 3), the period from the start of the expansion stroke injection to the start of the ignition period is longer than that when the normal fuel is used by changing the start timing of the expansion stroke injection to the advanced side. Also, in this case, the effects which are substantially the same as those of the lower part (iii) of FIG. 7 can be obtained.

For example, when the total injection amount of the injector 30 in each cycle is equal to that when the normal fuel is used and the injection share ratio is changed to increase the injection amount of the intake stroke injection as compared with the case where the normal fuel is used, the combustion for generating the initial flame is stabilized. However, in this case, the injection amount of the expansion stroke injection is reduced as compared with the case where the normal fuel is used so that the initial combustion is unstable. As a result, it is difficult to suppress the combustion fluctuation between cycles. However, even when the combustion for generating the initial flame is somewhat unstable, a series of combustion from the generation to the growth of the initial flame can be finally stabilized by stabilizing the subsequent initial combustion. Based on such consideration, in the present embodiment, the injection share ratio is changed to increase the injection amount of the expansion stroke injection which relatively largely contributes to the stabilization of the combustion fluctuation between cycles as compared with the case where a normal fuel is used.

FIG. 8 is a graph showing an example of the injection share ratio when the heavy fuel is used. As shown in FIG. 8, the ratio of the expansion stroke injection to the total injection amount of the injector 30 in each cycle is changed according to the reduction in the engine speed NE. For example, the reduction in the engine speed NE is calculated as a drop of the engine speed NE between the time t₁ and the time t₂ illustrated in FIG. 6. As the drop is larger, the injection share ratio is changed to increase the ratio of the expansion stroke injection to the total injection amount of the injector 30 in each cycle. However, when the injection amount of the intake stroke injection is extremely reduced, the combustion itself for generating the initial flame is hardly generated. Therefore, an upper limit value shown in FIG. 8 is given to the ratio of the expansion stroke injection to the total injection amount of the injector 30 in each cycle. Note that the relationship between the engine speed NE described in FIG. 8 and the ratio of the expansion stroke injection to the total injection amount of the injector 30 in each cycle is mapped by previous simulation or the like, is stored in the memory of the ECU 40, and is read out from the memory to perform the catalyst warming-up control.

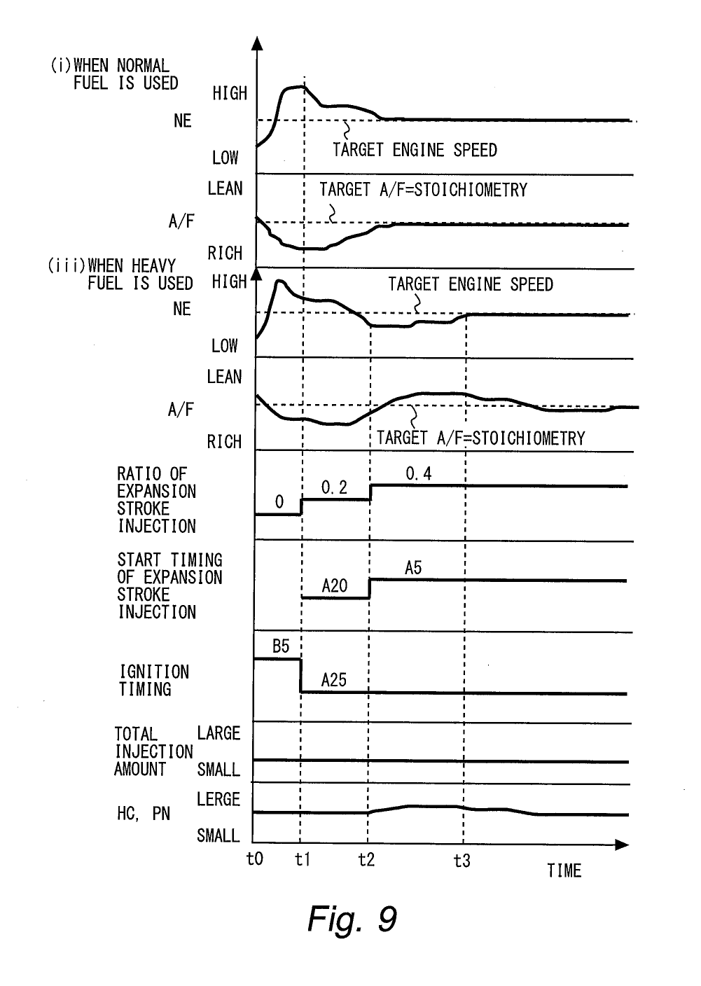

FIG. 9 is a time chart illustrating an example of the catalyst warming-up control according to the first embodiment of the present application. An upper part (i) of FIG. 9 represents the time chart of the catalyst warming-up control when the normal fuel is used, and a lower part (iii) of FIG. 9 represents the time chart of the catalyst warming-up control when the total injection amount of the injector 30 in each cycle is increased. Note that a time t₀ to a time t₂ illustrated in FIG. 9 correspond to the time t₀ to the time t₂ of FIG. 6, respectively. The control performed between the time t₀ and the time t₂ is overlapped in content with the control performed between the time t₀ and the time t₂ of FIG. 6. Therefore, the descriptions thereof are omitted.

As illustrated in the lower part (iii) of FIG. 9, when the catalyst warming-up control is started at the time t₁, the ignition timing is changed from B5 (BTDC 5°) to A25 (ATDC 25°). The start timing of the expansion stroke injection is set to A20 (ATDC) 20°, and the ratio of the expansion stroke injection to the total injection amount is set at 0.2. Before the time t₁ when the catalyst warming-up control is started, the injection and the ignition are performed in the intake stroke. Therefore, the ratio of the expansion stroke injection to the total injection amount between the time t₀ and the time t₁ is set at zero.

As illustrated in the lower part (iii) of FIG. 9, the total injection amount of the injector 30 in each cycle starts to increase at the time t₂. After the time t₂, the ignition period and the total injection amount are the same as those before the time t₂, though the start timing of the expansion stroke injection is set to A5 (ATDC 5°) and the ratio of the expansion stroke injection to the total injection amount is set at 0.4. When such a setting change is performed, the engine speed NE is gently increased and is converged to a target value substantially after the time t₃. That is, the combustion fluctuation between cycles can be suppressed. Since the total injection amount is not changed after and before the time t₂, as illustrated in the lower part (iii) of FIG. 9, the amount of HC (hydrocarbon) and PN (the number of particles) can be suppressed as compared with a case where the total injection amount is increased (see the lower part (ii) of FIG. 6). In addition, the deterioration of the fuel consumption ratio can be suppressed.

### Specific Process in First Embodiment

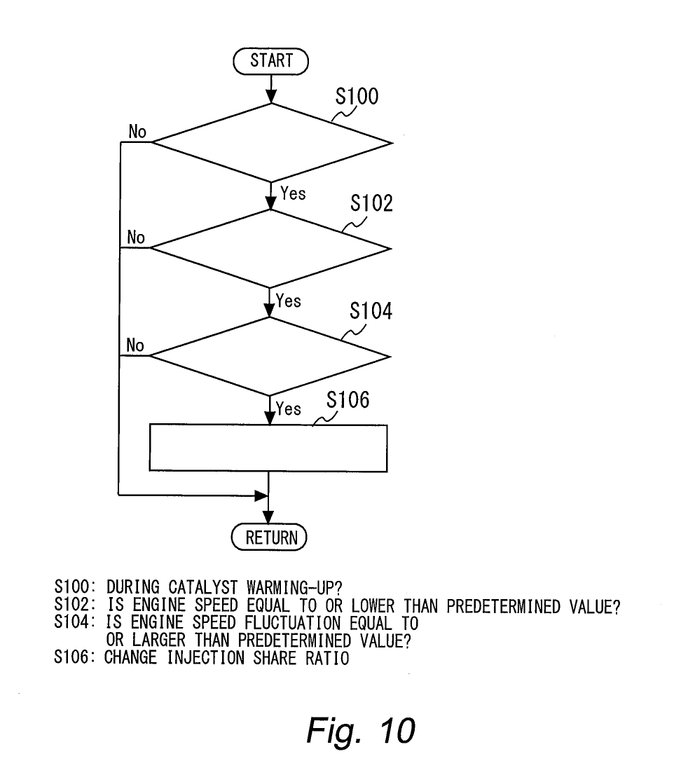

FIG. 10 is a flowchart illustrating an example of a process performed by the ECU 40 in the first embodiment of the present application. Note that routines illustrated in this figure are repeatedly performed in each cylinder by cycle after the start-up of the internal combustion engine 10.

In the routines illustrated in FIG. 10, first, it is determined whether an operation mode to perform the catalyst warming-up control (hereinafter referred to as a “catalyst warming-up mode”) is selected. For example, the catalyst warming-up mode is selected when it is determined that an engine coolant temperature is equal to or higher than a predetermined value in accordance with a detection value of the temperature sensor 46. When it is determined that the catalyst warming-up mode is not selected (in a case of “No”), the process goes out of this routine.

When it is determined that catalyst warming-up mode is selected in step S100 (in a case of “Yes”), it is determined whether the engine speed NE is equal to or lower than the predetermined value (step S102). The determination in step S102 corresponds to the determination whether the control performed immediately after the start-up of the internal combustion engine 10 (specifically, control performed between the time t₀ and the time t₁ illustrated in FIG. 9) is completed. When the engine speed NE is higher than the predetermined value (in a case of “No”), it can be determined that the control performed immediately after the start-up of the internal combustion engine 10 is not completed, and the process goes out of this routine to wait the catalyst warming-up control.

When it is determined that the engine speed NE is equal to or lower than the predetermined value in step S102 (in a case of “Yes”), it is determined whether the fluctuation of the engine speed NE is equal to or higher than the predetermined value (step S104). In step S104, for example, an average of times required in the expansion strokes in past several cycles before the current cycle is calculated as the fluctuation of the engine speed NE, and the calculated average value is compared with the predetermined value. When it is determined that the average value is smaller than the predetermined value (in a case of “No”), it can be estimated that the combustion fluctuation between cycles does not increase, and the process goes out of this routine. On the other hand, when it is determined that the average value is equal to or larger than the predetermined value (in a case of “Yes”), it can be estimated that the combustion fluctuation between cycles increases, and the process proceeds to step S106.

In step 5106, the injection share ratio is changed. In step 5106, the injection share ratio is changed in accordance with a map indicating the relationship between the engine speed NE described in FIG. 8 and the ratio of the expansion stroke injection to the total injection amount of the injector 30 in each cycle. As a result, in the next time cycle, the intake stroke injection and the expansion stroke injection are performed in accordance with the changed injection share ratio.

According to the above described routines illustrated in FIG. 10, when it is estimated that the combustion fluctuation between cycles increases, the total injection amount of the injector 30 in each cycle is equal to that when the normal fuel is used, and the injection share ratio can be changed to increase the injection amount of the expansion stroke injection as compared with the case where the normal fuel is used. Accordingly, even when the heavy fuel is used, the combustion fluctuation between cycles during the catalyst warming-up control can be suppressed, thereby preventing the drivability from being affected. In addition, the increase of HC (hydrocarbon) and PN (the number of particles) can be suppressed.

### Modification of First Embodiment

In the first embodiment, the tumble flow formed in the combustion chamber 20 swirls from the upper part of the combustion chamber 20 downward at the exhaust port 24 side and from the lower part of the combustion chamber 20 upward at the intake port 22 side. However, the tumble flow may swirl in a direction opposite to this flow direction, that is, the tumble flow may swirl from the upper part of the combustion chamber 20 downward at the intake port 22 side and from the lower part of the combustion chamber 20 upward at the exhaust port 24 side. In this case, it is necessary to change a location of the spark plug 32 from the exhaust valve 28 side to the intake valve 26 side. By thus changing the location of the spark plug 32, the spark plug 32 is located on the downstream side of the injector 30 in the tumble flow direction, thereby achieving the attraction action by the expansion stroke injection.

Furthermore, the tumble flow may not be formed in the combustion chamber 20, because the above-described combustion fluctuation between cycles occurs regardless of the presence of the tumble flow formation.

Note that this modification related to such a tumble flow can be similarly applied to second and third embodiments described later.

In the first embodiment, the first time injection (first injection) by the injector 30 is performed in the intake stroke, and the second time injection (second injection) is performed in the expansion stroke at the timing retarded from the compression top dead center. However, the first time injection (first injection) may be also performed in the compression stroke. In addition, the first time injection (first injection) may be dividedly performed in a plurality of times, or a divided part of the first time injection may be also performed in the intake stroke and the remainder may be also performed in the compression stroke. Thus, the injection timing and the number of injections in the first time injection (first injection) may be modified in various ways.

Note that this modification related to the injection timing and the number of injections in the first time injection can be similarly applied to the second and third embodiments described later.

In the first embodiment, in the routines illustrated in FIG. 10, it is detected that the combustion fluctuation between cycles occurs in accordance with the determination related to the fluctuation of the engine speed NE (specifically, a process of step S104). However, for example, after a fuel property sensor is provided in the fuel supply system which is connected to the injector 30 to specify the property of the fuel in use to some extent in accordance with the detection value of the fuel property sensor, it may be specified from both of the specified fuel property and the determination result related to the fluctuation of the engine speed NE that the factor that causes the combustion fluctuation between cycles is that the heavy fuel is used. When the fuel in use is specified as described above, the combustion fluctuation between cycles can be properly suppressed even though the heavy fuel is used.

Note that this modification related to specifying the fuel in use can be similarly applied to the second and third embodiments described later.

### Second Embodiment

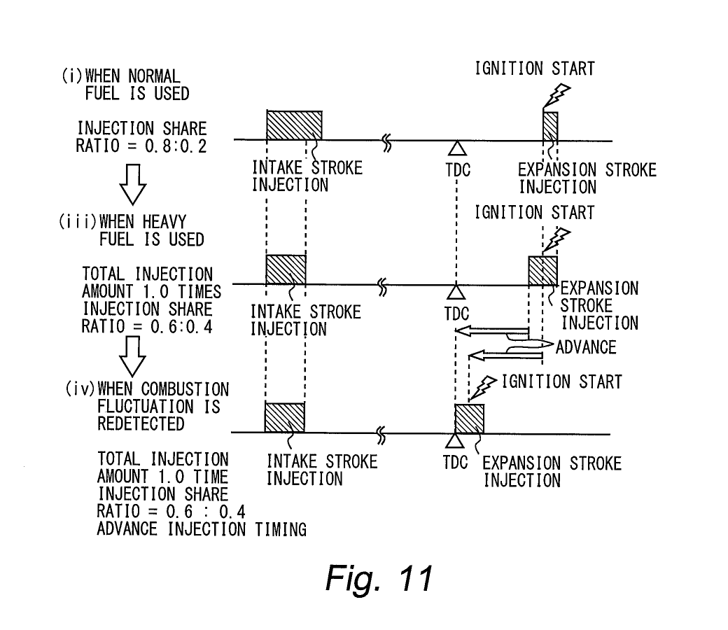

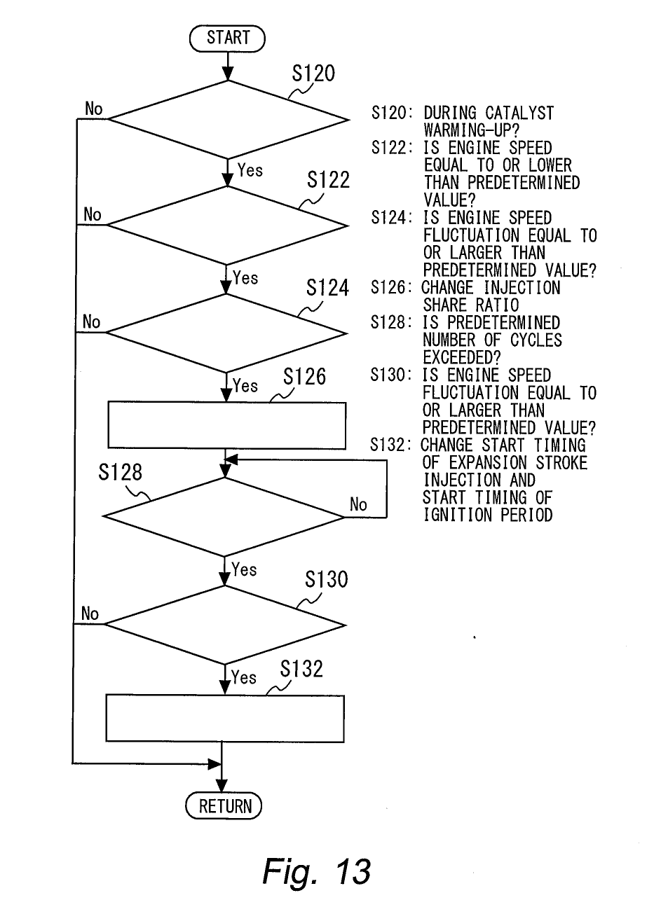

Next, the second embodiment of the present application is described with reference to FIGS. 11 and 13.

Note that the present embodiment is based on the assumption that the system configuration illustrated in FIG. 1 is applied. Therefore, the descriptions thereof are omitted.

### Characteristic of Catalyst Warming-up Control According to Second Embodiment

In the first embodiment, the injection share ratio is changed to increase the injection amount of the expansion stroke injection without changing the total injection amount of the injector 30 in each cycle when it is detected that the combustion fluctuation between cycles occurs. However, even if the injection share ratio is thus changed, the combustion fluctuation between cycles may not be suppressed. In the present embodiment, when the combustion fluctuation is redetected after the injection share ratio is changed, the start timing of the expansion stroke injection is changed to the advanced side so that it approaches the compression top dead center, and the start timing of the ignition period is changed to the advanced side by the same amount as the advanced amount of the start timing of the expansion stroke injection.

FIG. 11 is a diagram illustrating an outline of the catalyst warming-up control according to the second embodiment of the present application. Each of an upper part (i), a middle part (iii), and a lower part (iv) of FIG. 11 represents the outline of the catalyst warming-up control according to the present embodiment. The upper part (i) represents the catalyst warming-up control when the normal fuel is used, the middle part (iii) represents the catalyst warming-up control when the heavy fuel is used, and the lower part (iv) represents the catalyst warming-up control when the combustion fluctuation is redetected. Note that the upper part (i) and the middle part (iii) of FIG. 11 are the same in content as the upper part (i) and the lower part (iii) of FIG. 7. As understood from a comparison between the middle part (iii) and the lower part (iv) of FIG. 11, when the combustion fluctuation is redetected after the injection share ratio is changed, the start timing of the expansion stroke injection is advanced to near the compression top dead center, and then the start timing of the ignition period is advanced by the same amount as the advanced amount of the start timing of the expansion stroke injection.

An in-cylinder volume is reduced near the compression top dead center and an in-cylinder temperature is increased. Thus, when the start timing of the expansion stroke injection is advanced to near the compression top dead center, the atomization of the heavy fuel is promoted by the expansion stroke injection performed at a relatively high in-cylinder temperature, thereby suppressing the combustion fluctuation between cycles. When the start timing of the ignition period is advanced by the same amount as the advanced amount of the start timing of the expansion stroke injection, a difference in the attraction action can be prevented from being generated between the middle part (iii) and the lower part (iv) of FIG. 11, thereby preventing from affecting the atomization of the heavy fuel promoted by the expansion stroke injection performed at the relatively high in-cylinder temperature unexpectedly. Note that the advanced amount of the start timing of the expansion stroke injection may be different from that of the start timing of the ignition period within a range to prevent from thus affecting unexpectedly.

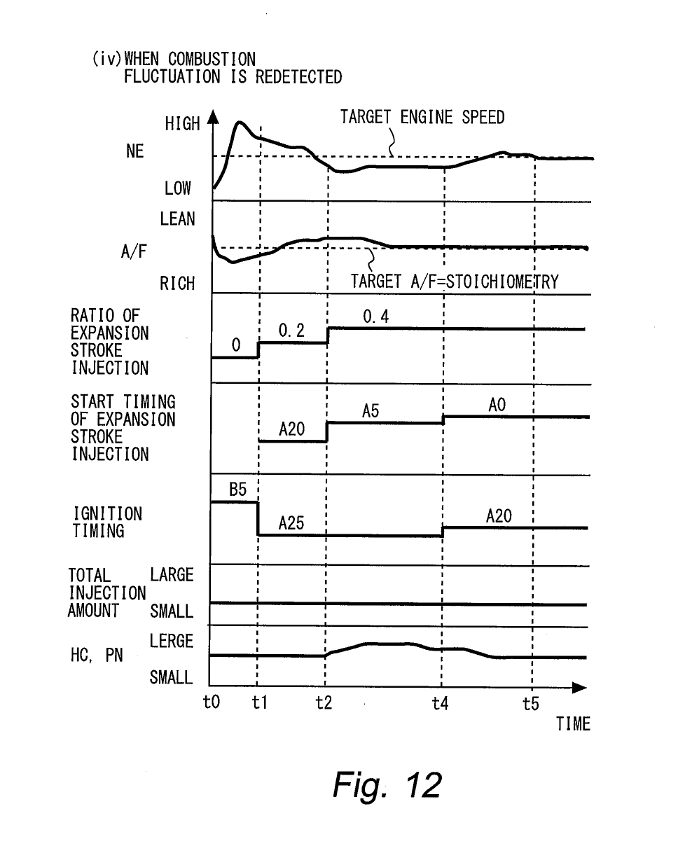

FIG. 12 is a time chart illustrating an example of the catalyst warming-up control according to the second embodiment of the present application. Note that a time t₀, a time t₁, and a time t₂ illustrated in FIG. 12 correspond to the time t₀, the time t₁, and the time t₂ in illustrated FIG. 6, respectively. The contents of control performed between the time t₀ and the time t₂ have been described in FIG. 6. Therefore, the descriptions thereof are omitted

As illustrated in FIG. 12, the total injection amount of the injector 30 in each cycle starts to increase at the time t₂. After the time t₂, the ignition period and the total injection amount are the same as those before the time t₂, though the start timing of the expansion stroke injection is set to A5 (ATDC 5°) and the ratio of the expansion stroke injection to the total injection amount is set at 0.4. When such a setting change is performed, the engine speed NE is gently increased. The increase in the engine speed NE after the time t₂ is basically the same as that after the time t₂ illustrated in FIG. 9.

Unlike FIG. 9, in FIG. 12, the engine speed NE is not converged to the target value at the time t₄. After the time t₄, the total injection amount and the ratio of the expansion stroke injection to the total injection amount are set to the same values as those before the time t₄, the start timing of the expansion stroke injection is set to A0 (TDC), and the start timing of the ignition period is set to A20 (ATDC 20°). Thus, the engine speed NE is converged to the target value substantially at the time t₅. That is, the combustion fluctuation between cycles can be suppressed.

### Specific Process In Second Embodiment

FIG. 13 is a flowchart illustrating an example of a process performed by the ECU 40 in the second embodiment of the present application. Note that routines illustrated in this figure are repeatedly performed in each cylinder by cycle after the start-up of the internal combustion engine 10.

In the routines in Fig, 13, processes of steps S120 to S126 are performed. Process contents of steps S120 to S126 are identical to those in steps S100 to S106 in FIG. 10. Therefore, the descriptions thereof are omitted.

Subsequently to step S126, it is determined whether the number of cycles integrated from the cycle when the injection share ratio is changed exceeds the predetermined number of cycles (step S128). The process in step S128 is repeatedly performed until it is determined that the number of cycles exceeds the predetermined number of cycles. When it is determined that the number of cycles exceeds the predetermined number of cycles, it is determined whether the fluctuation of the engine speed NE is equal to or higher than the predetermined value (step S130). The process of step S130 is identical to the process of step S124 (i.e., the process of step S104 in FIG. 10).

In step S130, for example, an average of times required in the expansion strokes in past several cycles before the current cycle is calculated as the fluctuation of the engine speed NE, and the calculated average value is compared with the predetermined value. When it is determined that the average value is smaller than the predetermined value (in a case of “No”), it can be estimated that the combustion fluctuation between cycles can be suppressed by the change of the injection share ratio, and the process goes out of this routine. On the other hand, when it is determined that the average value is equal to or larger than the predetermined value (in a case of “Yes”), it can be estimated that the combustion fluctuation between cycles cannot be suppressed though the injection share ratio is changed, and the process proceeds to step S132.

In step S132, the start timing of the expansion stroke injection and the start timing of the ignition period are changed. In step S132, the start timing of the expansion stroke injection and the start timing of the ignition period are advanced by the amount described in FIG. 12, for example. The advanced amount of the start timing of the ignition period is the same as that of the start timing of the expansion stroke injection.

According to the above described routines illustrated in FIG. 13, when it is estimated that the combustion fluctuation between cycles cannot be suppressed though the injection share ratio is changed, the start timing of the expansion stroke injection can be advanced to near the compression top dead center. Accordingly, the atomization of the heavy fuel is promoted by the expansion stroke injection, thereby suppressing the combustion fluctuation between cycles. In addition, since the start timing of the ignition period can be advanced by the same amount as the advanced amount of the start timing of the expansion stroke injection, a difference in the attraction action can be prevented from being generated, thereby preventing from affecting the atomization of the heavy fuel promoted by the expansion stroke injection performed at the relatively high in-cylinder temperature unexpectedly.

### Third Embodiment

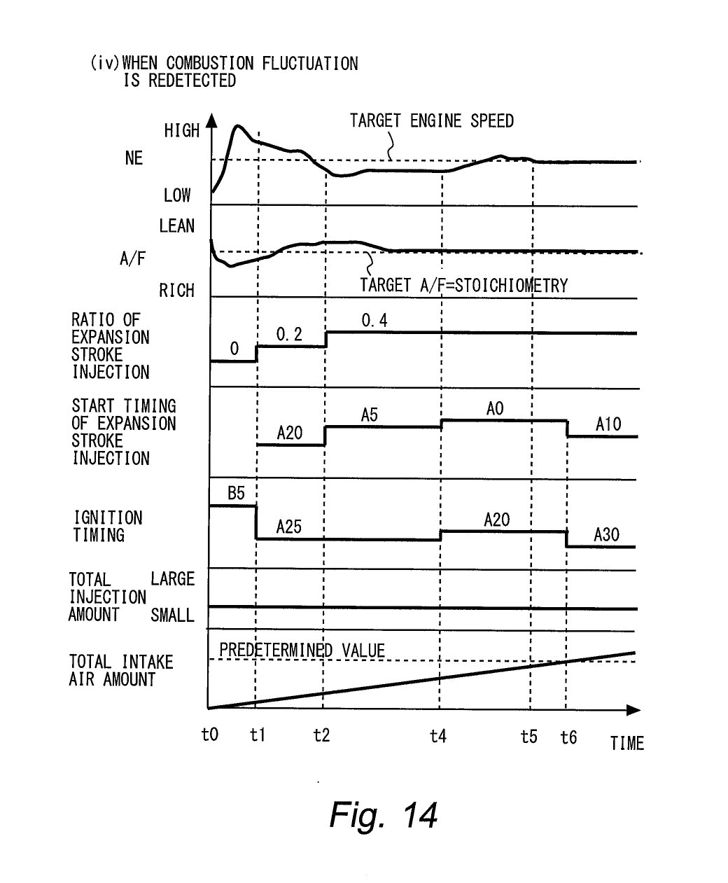

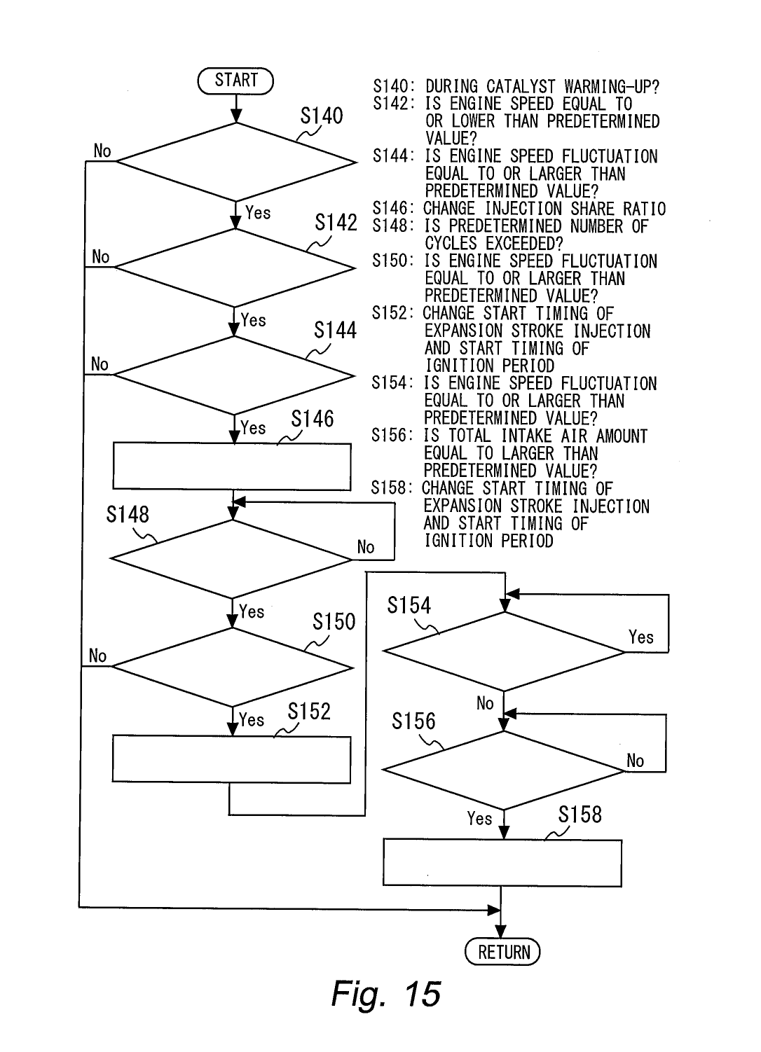

Next, the third embodiment of the present application is described with reference to FIGS. 14 to 15.

Note that the present embodiment is based on the assumption that the system configuration illustrated in FIG. 1 is applied. Therefore, the descriptions thereof are omitted.

### Characteristic of Catalyst Warming-up Control According to Third Embodiment

In the second embodiment, when it is estimated that the combustion fluctuation between cycles cannot be suppressed though the injection share ratio is changed, the start timing of the expansion stroke injection and the start timing of the ignition period are changed to the advanced side. However, when the start timing of the ignition period is advanced, the exhaust energy to be applied to the exhaust gas cleaning catalyst is reduced as compared with the case where the start timing of the ignition period is not changed to the advanced side, and the intended activation of the exhaust gas cleaning catalyst may not be achieved. In the present embodiment, when it is determined that the start timing of the expansion stroke injection and the start timing of the ignition period are advanced to enhance the combustion stability, and that the internal combustion engine 10 is warmed up sufficiently, the start timing of the ignition period is changed to the retarded side from the start timing before the change to the advanced side to compensate the exhaust energy reduced in response to the change of the start timing of the ignition period to the advanced side.

FIG. 14 is a time chart illustrating an example of the catalyst warming-up control according to the third embodiment of the present application. Note that a time t₀, a time t₁, and a time t₂ illustrated in FIG. 14 correspond to the time t₀, the time t₁, and the time t₂ in illustrated FIG. 6, respectively. The contents of control performed between the time t₀ and the time t₂ have been described in FIG. 6. Note that a time t₄, and a time t₅ illustrated in FIG. 14 correspond to the time t₄, and the time t₅ in illustrated FIG. 12, respectively. The contents of control performed between the time t₄ and the time t₅ have been described in FIG. 12. Therefore, the descriptions thereof are omitted.

As illustrated in FIG. 14, the engine speed NE is converged to the target value after the time t₅. This is as described in FIG. 12. The start timing of the ignition period is changed to the retarded side at the time t₆ when the total intake air amount in the internal combustion engine 10 integrated from the time t₀ reaches the predetermined value. After the time t₆, the total injection amount and the ratio of the expansion stroke injection to the total injection amount are set to the same values as those before the time t₆, the start timing of the expansion stroke injection is set to A10 (TDC 10°), and the start timing of the ignition period is set to A30 (ATDC 30°). The start timing of the ignition period as well as the start timing of the expansion stroke injection are changed to the retarded side to prevent a difference in the attraction action from being generated and to prevent from unexpectedly affecting the compensation of the exhaust energy performed by changing the start timing of the ignition period to the retarded side. In FIG. 14, the start timing of the expansion stroke injection is changed to the retarded side by the same amount as the retarded amount of the start timing of the ignition period. Note that the retarded amount of the start timing of the expansion stroke injection may be different from that of the start timing of the ignition period within a range to prevent from thus affecting unexpectedly.

Since at the time t₆ in FIG. 14, the start timing of the ignition period is set to A30 (ATDC 30°), the retarded amount is CA5° when the start timing of the ignition period before the change to the advanced side, that is, the start timing (ATDC 25°) of the ignition period from the time t₁ to the time t₄ in FIG. 14 is taken as reference. This retarded amount is exemplified as an example. In practice, the retarded amount is calculated by the ECU 40 in accordance with a loss of the exhaust energy generated by the change to the advanced side which is calculated based on the start timing of the ignition period from the time t₁ to the time t₄ and the intake air amount during a period from the time t₁ to the time t_{4,} a remaining time which is remaining during a period from the time t₆ to a time point when the catalyst warming-up control is completed, and an intake air amount at the time t₆. If the start timing of the ignition period is retarded based on the retarded amount thus calculated, the activation of the exhaust gas cleaning catalyst can be achieved before the completion of the catalyst warming-up control which is performed over the set time after the start-up of the internal combustion engine 10. Note that the time when the catalyst warming-up control is completed is the time when the above-described set time is elapsed from the time when the catalyst warming-up control is started (i.e. the time t₁ in FIG. 4), and is calculated by the ECU 40.

### Specific Process In Third Embodiment

FIG. 15 is a flowchart illustrating an example of a process performed by the ECU 40 in the third embodiment of the present application. Note that routines illustrated in this figure are repeatedly performed in each cylinder by cycle after the start-up of the internal combustion engine 10.

In the routines in FIG. 15, processes of steps S140 to S152 are performed. Process contents of steps S140 to S156 are identical to those in steps S120 to S132 in FIG. 13. Therefore, the descriptions thereof are omitted.

Subsequently to step S152, it is determined whether the fluctuation of the engine speed NE is equal to or higher than the predetermined value (step S154). The process of step S154 is identical to the processes of steps S144 and S150 (i.e., the process of step S104 in FIG. 10). In step S154, for example, an average of times required in the expansion strokes in past several cycles before the current cycle is calculated as the fluctuation of the engine speed NE, and the calculated average value is compared with the predetermined value. The process in step S154 is repeatedly performed until it is determined that the average value is smaller than the predetermined value. When it is determined that the average value is smaller than the predetermined value (in a case of “No”), it can be estimated that the combustion stability is enhanced by advancing the start timing of the expansion stroke injection and the start timing of the ignition period, and the process proceeds to step S156.

In step S156, it is determined whether the total amount of the intake air after the start-up of the internal combustion engine 10 is above the predetermined value. The total amount of the intake air after the start-up of the internal combustion engine 10 is calculated in accordance with a detection value of the air flow meter 42, for example. The process in step S156 is repeatedly performed until it is determined that the total amount of the intake air is above the predetermined value. When it is determined that the total amount of the intake air is above the predetermined value (in a case of “Yes”), it can be estimated that the internal combustion engine 10 is warmed up sufficiently, and the process proceeds to step 5158.

In step S158, the start timing of the expansion stroke injection and the start timing of the ignition period are changed. In step S158, the start timing of the expansion stroke injection and the start timing of the ignition period are retarded by the amount described in FIG. 14, for example. The retarded amount of the start timing of the ignition period is calculated as described above. The retarded amount of the start timing of the expansion stroke injection is the same as that of the start timing of the ignition period.

According to the above described routines illustrated in FIG. 15, when it is determined that the combustion stability is enhanced by advancing the start timing of the expansion stroke injection and the start timing of the ignition period, and the internal combustion engine 10 is warmed up sufficiently, the start timing of the ignition period can be retarded from the start timing of the ignition period before the change to the advanced side. Accordingly, the exhaust energy reduced in response to the change of the start timing of the ignition period to the advanced side can be compensated and the activation of the exhaust gas cleaning catalyst can be achieved before the completion of the catalyst warming-up control which is performed over the set time after the start-up of the internal combustion engine 10. The start timing of the expansion stroke injection can be advanced by the same amount as the advanced amount of the start timing of the ignition period, thereby preventing a difference in the attraction action from being generated, and preventing from unexpectedly affecting the compensation of the exhaust energy performed by changing the ignition period to the retarded side.

What is claimed is:

1. A control device for an internal combustion engine, the internal combustion engine comprising:
an injector which is provided in an upper part of a combustion chamber and is configured to inject fuel from a plurality of injection holes into a cylinder;
a spark plug which is configured to ignite an air-fuel mixture in the cylinder using a discharge spark, the spark plug being provided on a downstream side of the fuel injected from the plurality of injection holes and above a contour surface of a fuel spray pattern which is closest to the spark plug among the fuel spray patterns injected from the plurality of injection holes; and
an exhaust gas cleaning catalyst which is configured to clean an exhaust gas from the combustion chamber,
wherein in order to activate the exhaust gas cleaning catalyst, the control device is configured to control the spark plug so as to generate the discharge spark in an ignition period retarded from a compression top dead center, and control the injector so as to perform first injection at a timing advanced from the compression top dead center and second injection at a timing retarded from the compression top dead center, the second injection being performed so that an injection period overlaps with at least a part of the ignition period, and
the control device is further configured to divide an injection amount into the first injection and the second injection in accordance with an injection amount in each cycle and a previously set injection share ratio, and when an engine speed fluctuation is detected, change the injection share ratio without changing the injection amount in each cycle so that the injection amount of the second injection is increased, and the injection amount of the first injection is reduced.

2. The control device for an internal combustion engine according to claim 1, wherein the control device is further configured to change the injection share ratio when an engine speed fluctuation is detected and a use of a heavy fuel is detected.

3. The control device for an internal combustion engine according to claim 1, wherein the control device is further configured to change a start timing of the ignition period to an advanced side when the engine speed fluctuation is detected though the first injection and the second injection are performed at the changed injection share ratio.

4. The control device for an internal combustion engine according to claim 3, wherein the control device is further configured to change the start timing of the second injection to the advanced side by the same amount as an advanced amount of the start timing of the ignition period when the start timing of the ignition period is changed to the advanced side.

5. The control device for an internal combustion engine according to claim 3, wherein the control device is further configured to change the start timing of the ignition period to a retarded side from the start timing before the change to the advanced side when the engine speed fluctuation is not detected after the start timing of the ignition period is changed to the advanced side.

6. The control device for an internal combustion engine according to claim 5, wherein the control device is further configured to change the start timing of the second injection to the retarded side by the same amount as a retarded amount of the start timing of the ignition period when the start timing of the ignition period is changed to the retarded side from the start timing before the change to the advanced side.

7. The control device for an internal combustion engine according to claim 5, wherein
the control device is further configured to calculate the retarded amount when the start timing of the ignition period is changed to the retarded side in accordance with a loss of exhaust energy, a remaining time and an intake air amount generated with the change of the start timing of the ignition period to the advanced side,
the loss of the exhaust energy is calculated in accordance with an advanced amount when the start timing of the ignition period is changed to the advanced side, and a total amount of the intake air when the start timing of the ignition period is changed to the advanced side,
the remaining time is a time remaining during a period from a time point when the engine speed fluctuation is not detected after the start timing of the ignition period is changed to the advanced side to a time point when a control for activating the exhaust gas cleaning catalyst is completed, and
the intake air amount is an air amount taken into the internal combustion engine at a time point when the engine speed fluctuation is not detected after the start timing of the ignition period is changed to the advanced side.
